(19) United States
(12) Patent Application Publication
(10) Pub. No.: US 2003/0125023 A1
(43) Pub. Date: Jul. 3, 2003

(54) Method and system for providing a wireless terminal communication session integrated with data and voice services

(76) Inventor: Eyal Fishler, Tel Aviv (IL)

Correspondence Address: VENABLE, BAETJER, HOWARD AND CIVILETTI, LLP, P.O. BOX 34385, WASHINGTON, DC, 20043-9998, US

(21) Appl. No.: 10/276,244

(22) PCT Filed: Mar. 15, 2001
(86) PCT No.: PCT/IL01/00256

(51) Int. Cl. H04Q 7/20

(52) U.S. Cl. 455/426; 455/414

(57) ABSTRACT

In a communication network a method and system for integrating data and voice services into a single session. Subscribers in a wireless communication network are communicatively linked to information sources in a data network via a gateway. The subscribers submit requests to voice service providers in the data network. A data and voice switching server effects integration of the data and voice services within the current session by suspending the data session, opening an integrated voice and data session and maintaining the integrated session by controlling and coordinating the functionality of an access provider switch, a gateway server, a remote access server, and a voice server. Subscribers are provided integrated voice and data services within a single session. After the completion of the voice services the subscribers transparently reconnected to the data network by the voice and data switching server.

### BACKGROUND OF THE INVENTION

1. Field of the Invention

The present invention relates in general to wireless communication systems, and more specifically to a system and method for a controlled integration of data and voice into user interface associated with a single communication session managed from a wireless application protocol compliant mobile terminal.

2. Discussion of the Related Art

In the wireless communication market information services are becoming increasingly popular. Such services can provide subscribers with up-to-date information on news, sport results, stock prices, entertainment, flight information, ground transport, timetables, and the like. To increase the value and the scope of such services existing wireless communication systems now support access to global data communication networks such as the Internet and more specifically the World Wide Web (Web). The information stored on content providing sites across the Web can be accessed from wireless networks by utilizing appropriate Wireless Application Protocol (WAP)-compliant mobile stations, such as cellular telephone devices or Personal Digital Assistants (PDA). The Wireless Application Protocol (WAP) is an open, global standard that empowers mobile telephone users with wireless device to easily access and interact with information and services provided over the Web instantly.

When a subscriber using WAP initiates a connection to the Internet via a suitable user agent, the mobile device sends a conventional RF signal searching for the desired service. When an appropriate radio link or air link is made with the mobile network service provider the subscriber introduces a request for a specific content information by selecting and submitting the identification of a Web resource such as a Web page. The request is sent by the mobile network service provider to a gateway router, which completes the connection to the addressed Web site, retrieves the requested content information from the site and sends the data back along the same communication path to be processed by the subscriber's device.

The method of Web navigation via a wireless device utilizing the standard Wireless Access Protocol (WAP) has several disadvantages. One drawback concerns the simplifying of the received Web content due to the design constraints of a typical wireless device. The information retrieved by the gateway is typically a document formatted as an HTML file. The file typically includes highly formatted text content, and hyperlinks to provide navigational capabilities. Typically, the page further includes rich content such as graphics, sound, voice, animation, virtual reality, and the like. In order to fit the format of the document for display on the display area of the requesting wireless device and to the processing capabilities of the device the file is translated by a gateway server from the HTML format to the Wireless Markup Language (WML) format. According to the limitations of a typical mobile device, such as having a display area with minimal physical dimensions, and considerably reduced processing power, the original display format of the received information is simplified. Only carefully selected functional segments of the text are displayed on the screen of the mobile device. The page is clipped by the trimming of practically all the elements therein having advanced multimedia content. Following the elimination of most of the page contents by the clipping process, the options of the subscriber regarding the control of Web navigation by hypertext links are markedly reduced. Though the manner in which basic information is displayed is acceptable, the inputting of commands, Web addresses, e-mail messages, and the like, is inconvenient. Currently the only input option available to WAP subscribers is text typing on the miniature telephone or PDA keypad. In order to input a single letter up to 4 keystrokes are required, on a small size keypad, which is designed for numeric input. Textual form filling is practically impossible, and a prolonged information search is extremely tedious. Contacting multiple network content providers involves extended periods and repeated logins. It will be easily understood that slow-paced navigation on the Web effects the ability of service providers to offer attractive goods or services and to attract customers to use such environment in commercial transactions.

A particular problem concerning a WAP-based data session is the non-availability of the option to accept incoming calls. The wireless device is open for a single channel. Thus, while Web navigation is in progress, no incoming calls are available. If another party is trying to call a subscriber engaged in a data session, a busy signal is received or the call is transferred to the subscriber's voice-mail box. Even in multiple channel devices there is no interaction and integration between Voice and Data. Further shortcoming concerns the disablement of the entire set of voice services for the duration of a data session When the subscriber is engaged in a data session no voice services, such as acceptance and placement of calls, playing received voice messages, recording voice messages, advanced voice processing, or the like, can be used on the channel used for accessing the data communication network services. If the subscriber wishes to use a specific voice service the data connection must be terminated by an appropriate logout procedure. Note should be taken that voice services transmitted as data, such as Voice-over-IP (VoIP) can be received within the data session.

It will be easily perceived by one with ordinary skill in the art that a need exists for a solution for the existing shortcomings of WAP. A substantial improvement could be achieved by providing the subscribers engaged in data sessions with the option of utilizing conventional and advanced voice services in the framework of a single data session.

### SUMMARY OF THE PRESENT INVENTION

It is an object of the present invention to provide a new and novel method and system for automatically suspending and resuming data sessions of mobile telephone subscribers, thus enabling the subscribers to receive voice sessions and other services while engaging in data sessions.

One aspect according to an embodiment of the present invention regards a method for providing to the at least one subscriber device a communication session with integrated data and voice services that includes identifying the subscriber device associated with a data communication session in the first communication network, intercepting voice service related requests transmitted from the service provider device in the second communication network to the subscriber device associated with the data communication session in the first communication network, logically linking the intercepted voice service related requests from the service provider device in the second communication network with the subscriber device associated with the data communication session in the first communication network and suspending the data communication session associated with the subscriber device between the subscriber device in the first communication network and the second communication network.

Another aspect of the present invention in accordance with a preferred embodiment of the present invention further includes opening a virtual communication session associated with the subscriber device in the first communication network, performing the requested voice service within the framework of the virtual communication session associated with the subscriber device in the first communication network, and resuming the data communication session between the subscriber device associated with the data communication session in the first communication network and the second communication network.

A second aspect of an embodiment of the present invention regards a system for the management of a communication session with integrated data and voice services includes the elements of a data and voice switching server to control the integration of data and voice services into a data and voice session associated with the subscriber device in the first communication network, and a gateway device controller to suspend and resume the data communication session.

A third aspect of an embodiment of the present invention regards a method for providing the wireless devices associated with subscribers a data communication session having integrated data and voice services, the method includes classifying the subscriber device associated with a data communication session in the wireless communication network, capturing voice service requests forwarded from the service provider device through the gateway device in the data communication network to the wireless device associated with the data communication session in the wireless communication network, coupling the captured voice service requests from the service provider device in the data communication network to the wireless device associated with the data communication session in the wireless communication network, suspending the data communication session associated with the wireless device between the wireless device in the wireless communication network and the data communication network, opening a data and voice communication session associated with the wireless device in the wireless communication network, executing the requested voice service within the framework of the data and voice communication session associated with the wireless device in the wireless communication network, and resuming the suspended data communication session between the wireless device associated with the data communication session in the wireless communication network and the data communication network.

The above aspects of the present invention show the integration of data and voice services within a single communication session. The above aspects of the present invention enhance substantially optimized data communication network navigation. The above aspects of the present invention substantially improve the performance of the subscriber device. The above aspects of the present invention provides for substantially easing the load on the communication control devices of the wireless network. The above aspects of the present invention provides for substantially easing the load on the communication control devices of the data and voice network.

### BRIEF DESCRIPTION OF THE DRAWINGS

The present invention will be understood and appreciated more fully from the following detailed description taken in conjunction with the drawings in which:

FIG. 1 is a schematic block diagram of a mobile communication system incorporating elements operative in data network access known in the art; and

FIG. 2 is a schematic block diagram of the mobile communication system of FIG. 1 incorporating elements for providing data and voice services within a single session, in accordance with a preferred embodiment of the present invention; and

FIG. 3 is a schematic block diagram of the Data Voice Switching Server, in accordance with a preferred embodiment of the present invention; and

FIG. 4 is a block diagram illustrating the components functional in the operation of the Data Voice Switching Server, in accordance with a preferred embodiment of the present invention; and

FIG. 5 is a flowchart illustrating the Home Location Register configuration process, in accordance with a preferred embodiment of the present invention; and

FIG. 6 is a flowchart of the user parameters handling component, in accordance with a preferred embodiment of the present invention; and

FIG. 7 is illustrates the operation of the voice request handling component, in accordance with a preferred embodiment of the present invention; and

FIG. 8 illustrates the operation of the request handling component, in accordance with a preferred embodiment of the present invention; and

FIG. 9 illustrates the operation of the data session resumption component, in accordance with a preferred embodiment of the present invention.

### DETAILED DESCRIPTION OF THE PREFERRED EMBODIMENT

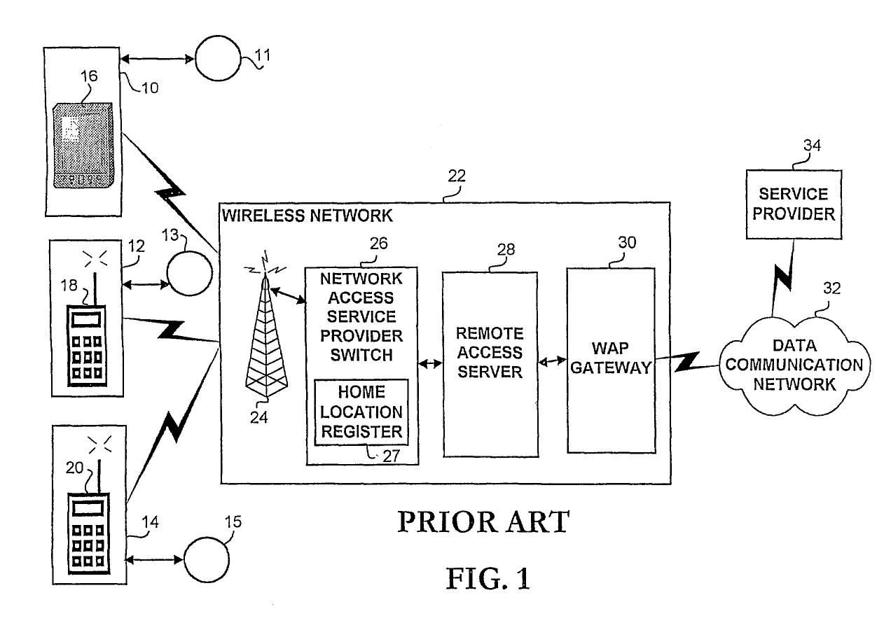

Referring to FIG. 1 there is depicted block diagram of a mobile communication system, incorporating elements operative in data network access known in the art. Cellular network subscribers 11,13,15 are associated with mobile stations 10,12,14 respectively. Stations 10,12, and 14 contain mobile terminals 16,18,20 respectively. Devices 18,20 are WAP-enabled cellular telephone devices such as Nokia 6210/7110, while device 16 is an WAP-enabled Personal Digital Assistance (PDA), such as Hewlett-Packard's Palmtop or 3Com's PalmPilot. It should be understood that other devices could be used, such as pagers, two-way radios, smart phones, and communicators. For clarity, FIG. 1 depicts only three mobile stations containing only three respective mobile terminals associated with only three respective cellular network mobile subscribers, but it will be appreciated that the system will incorporate a plurality of mobile stations each servicing its respective subscriber. Wireless devices 16,18,20 intermittently connect to wireless network 22 by utilizing a built-in radio transceiver. Wireless network 22 effectuates communication between the wireless devices 16,18,20 as well as between a plurality of wireless devices (not shown) associated with the network 22. Wireless network 22 could be any of the WAP-compliant wireless network types such as Cellular Digital Packet Data (CDPD), Code Division Multiple Access (CDMA), Global System for Mobile Communications (GSM), Time Division Multiplex (TDMA), Frequency Division Multiplex (FDM), and the like. Wireless network 22 further effectuates communication between the devices 16,18,20 and other communication networks such as a Public Switched Telephone Network (PSTN) or a data communication network, such as the Internet. Wireless network 22 includes base station 24, network access service provider switch 26, remote access server 28, and WAP gateway server 30. Also for clarity FIG. 1 depicts only one switch, one base station, one remote access server, and one WAP gateway server, but it will be appreciated that the system will incorporate a number of base stations, switches, and servers. Where the Cellular Digital Packet Data (CDPD) technology is used in the cellular network one or more one or more Direct Access Units (DAU) could be incorporated into the system. Base station 24 is operative in controlling the set of mobile stations 10,12,14. Station 24 receives the RF signals transmitted by devices 16,18,20 and forwards the respective signals to a network access service provider switch 26 utilizing conventional communication links. Switch 26 identifies the subscribers of the transmitting devices and creates a link between two mobile terminals utilizing conventional RF techniques. Switch 26 is also operative in creating a link between a mobile terminal and diverse other communication networks such as a PSTN or a data communication network utilizing both conventional RF techniques and convention communication links. Network access service provider switch 26 contains a Home Location Register (HLR) 27 database. HLR 27 is a centralized database for storing subscription data and other necessary network data associated with the mobile stations 10,12,14 or with the mobile subscribers 11,13,15 associated with the mobile stations 10,12,14 respectively. The HLR 27 further maintains data representative of the current location of the mobile stations 10,12,14. Remote access server 28 receives requests for connections to the network 32 from switch 26 and forwards the requests to a WAP gateway server 30. In wireless networks utilizing CDPD technology a Direct Access Unit (DA) will replace the remote access server 28. WAP gateway server 30 includes components for processing the requests, for accessing requested resources across network 34, and for returning the desired information content to the mobile subscriber. Additionally, WAP gateway server 30 functions as a proxy by providing for data caching message screening, and data session management. Data communication network 32 includes resources located on the specific data network sites. The resources comprise content information, applications data, services, and the like. Service provider 34 is a network site preferably incorporating an application server, a content provider server, and appropriate application programming interface routines (APIs).

When mobile subscriber 13 associated with mobile station 12 desires to access the data communication network 32 for interacting with specific resources, such as Web pages, mobile subscriber 13 instructs mobile terminal 18 to establish a connection to wireless network 22. Mobile terminal 18 sends a command to an incorporated internal modem or to an incorporated modem emulator to dial, to quick connect or to transfer to the data channel of the wireless network access service provider 26. Mobile subscriber 13 introduces a suitable request via a WAP-based micro-browser implemented within mobile terminal 18. A micro-browser is client software designed to enable wireless access to services such as Internet information in combination with a suitable network server.

The RF signal wrapping the request for the service is transmitted to the wireless network 22. After the connection is established with the network access service provider switch 26 the request for connection with network 32 is transferred using conventional communication lines via remote access server 28 to a specific WAP gateway server 30. Server 30 processes the request by performing a translation from Wireless Markup Language (WML) format to Hypertext Markup Language (HTML) format. Subsequently WAP gateway server 30 establishes connection via data communication network 32 with the service provider 34 using conventional communication links. The request for a specific resource effectuates the transmission of a specific Web document back to the WAP gateway 30. Gateway server 30 examines the returned document in order to determine the format thereof. If the document is formatted in the WML format then the gateway 30 transmits the document unmodified back to mobile terminal 18 in order to enable suitable interaction with the mobile subscriber 13. If the document received by gateway 30 is formatted as an HTML document then the gateway server 30 encodes the document to WML format prior of the transmission thereof back to mobile station 12 for interaction with the mobile subscriber 13. The suitably encoded document is displayed by the micro-browser implemented within the mobile terminal 18 on the display device of terminal 18.

The period of a connection between a mobile subscriber of a mobile communication session to a data communication network beginning with the initialization of the connection (i.e., the login process), and ending with the termination of the connection (i.e., the logout) is referred to as the “data session”. During the data session the mobile subscriber can selectively and dynamically interact with various resources associated with data network sites, such as information, applications, and services. The interaction with the retrieved content is performed within the prevailing hardware and software constraints of the mobile terminal device. While the mobile subscriber is engaged in a data session no voice services can be performed. Such services can be incoming calls, the playing of a voice message, the recording of a voice message, and the like. The aforementioned services are disabled for the duration of the connection to a data network. In order to utilize voice services the mobile subscriber has to terminate the data session by the sending of a suitable logout instruction to the micro-browser implemented within the mobile terminal device. If after the completion of a specific voice session the mobile subscriber desires to access the data network then a new login procedure has to be performed in order to open a new data session.

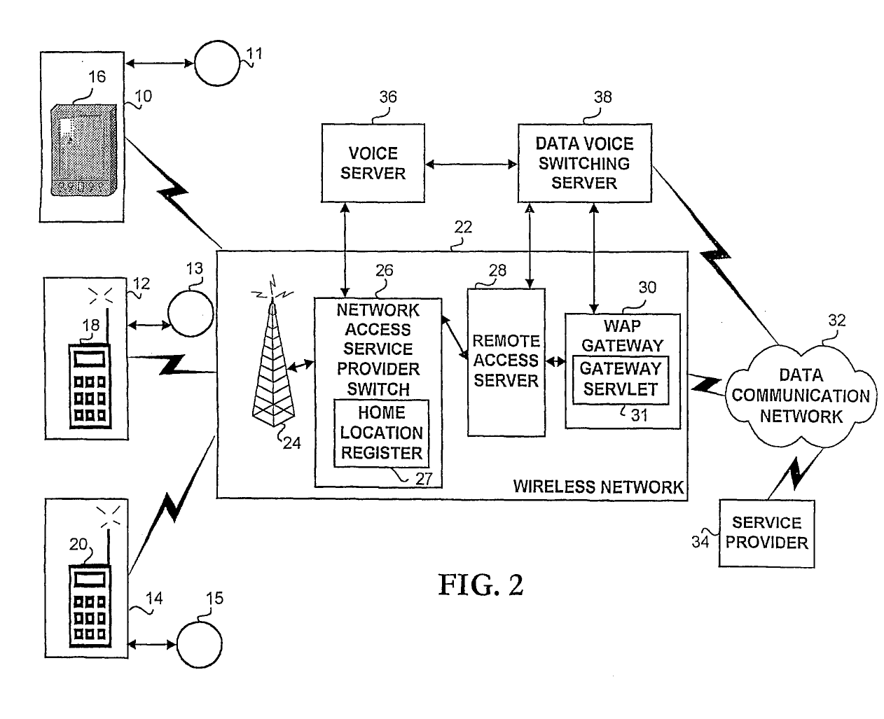

Referring now to FIG. 2 that illustrates a schematic block diagram of a mobile communication system including additional components that provide for the integration of data and voice services within the framework of a single data session, in accordance with a preferred embodiment of the present invention. The additional components described in the present invention enable a mobile subscriber to use voice services while engaged in a data session. As previously described in association with FIG. 1 cellular network mobile subscribers 11,13,15 are associated with mobile stations 10,12,14 respectively, which contain mobile terminals 16,18,20 respectively. Mobile terminals 16,18,20 intermittently connect to wireless network 22 by utilizing a built-in radio transceiver. Terminals 16,18,20 also include a modem or a modem emulator and a WAP-based micro-browser. Wireless network 22 effectuates communication between the terminals 16,18,20 and in the linking of a specific mobile terminal to diverse other communication networks. In the preferred embodiment of the present invention, the referred to data communication network is the Internet. Wireless network 22 includes base station 24, network access service provider switch 26, remote access server 28, data voice switching server 38, voice server 36, and WAP gateway server 30. Base station 24 controls the mobile stations 10,12,14 and receives the RF signals transmitted by devices 16,18,20. Station 24 forwards the respective signals to a network access service provider switch 26. Switch 26 identifies the mobile subscribers of the transmitting devices and creates an operative connection between the requesting wireless device and the data communication network. Network access service provider switch 26 contains a Home Location Register (HLR) 27 database. Data Voice Switching (DVS) server 38 enables the switching between voice and data channels and is operative in the setting up, control performance, and termination of the integrated data and voice session. DVS 38 has a unique inner design and a specific communication interaction with other communication systems. DVS 38 enables WAP-compliant wireless terminals, such as cellular phones, PDAs, and the like, to have a mixed-mode interface. Mixed-mode interface is defined as an interface that allows the mobile terminal device to activate both voice services and Web navigation within the same data session. Voice server 36 records and communicates voice segments associated with specific voice services within a specific data session. The voice segments are captured, stored, retrieved, reproduced, and played by the appropriate voice applications. Voice server 36 could be any one of a number of the currently marketed products, such as the IBM Websphere Voice Server or the DMV400/DMV4000 voice-processing platform developed and distributed by Intel Dialogic Corporation.

Remote access server 28 receives requests for connecting a mobile terminal to the data network 32 from switch 26 and forwards the requests to a WAP gateway server 30 using conventional communication lines and devices. WAP gateway server 30 includes components operative in the suitably processing of the requests, in the retrieval of the desired resources from network 34, and in the transmission of the desired content to the mobile subscriber. WAP gateway 30 also includes components providing proxy server-specific functions such as data caching, message screening, and data session control. Data communication network 32 includes resources located on specific network sites. The resources contain content information, applications data, and services. Service provider 34 is a network site incorporating various services. In the preferred embodiment of the present invention, service provider 34 implements voice services containing voice application routines, voice contents, and voice processing-specific application program interface (API) routines.

When mobile subscriber 13 associated with mobile station 12, desires to access data communication network 32 for interacting with specific resources, such as Web pages, mobile subscriber 13 instructs mobile device 18 to establish a connection to wireless network 22. Mobile device 18 sends a command to the implemented internal modem therein or to the implemented modem emulator therein, to dial, to quick connect or to transfer to the data channel of the wireless network access service provider 26. Subscriber 13 introduces a request via a WAP-based micro-browser implemented within wireless device 18. The associated RF signal for the service is transmitted towards the wireless network 22. After the connection is established with the network access service provider switch 26 the request for connection with network 32 is transferred via remote access server 28 to a WAP gateway server 30 utilizing port numbers, such as 9200 or 9203. Server 30 processes the request by performing a translation from Wireless Markup Language (WML) format to Hypertext Markup Language (HTML) format. Subsequently WAP gateway server 30 establishes connection via data communication network 32 with service provider 34. The request for a specific resource effects the transmission of a specific Web document back to WAP gateway 30. Next, gateway server 30 determines the format of the document. If the document is in WML format then gateway 30 transmits the document unmodified back to wireless device 18 in order to enable interaction with subscriber 13. If the document received by gateway 30 is in HTML format then gateway server 30 encodes the document to WML format prior of the transmission thereof back to mobile station 12 for interaction with subscriber 13. The suitably encoded document is displayed by the micro-browser on the display device of the wireless device 18.

In contrast with the operation of a conventional mobile communication network, the network described on FIG. 2 makes available the option of activating and performing voice services within a data session without compelling the termination of the current data session. Thus, the mobile subscriber can selectively and dynamically interact with diverse resources associated with data network sites, such as information content, applications and services within the prevailing hardware-specific constraints of the mobile terminal device and accept or demand voice services within a single data session. By utilizing the proposed method and system, voice services such as the submission of voice messages, voice replies to e-mail, speaker recognition, voice recognition, text-to-speech, and other advanced voice technologies can be efficiently and seamlessly integrated into a WAP (text only) session. Such technologies can be integrated into the proposed system and method by the utilization of available software products distributed by known vendors. For example, vendors of speech recognition software include IBM, Nuance, Philips Electronics NV and SpeechWorks.

In order to provide a detailed description of the method and system according to the teaching of the present invention an exemplary voice service will be used. Such description is shown for the purpose of clarity and not limitation. Thus, in the preferred embodiment of the present invention, the specific voice service required by the subscriber and supplied by the system will be a voice message reply to an e-mail message. The service involves the basic ability of recording, storing, and manipulating spoken messages. When a WAP mobile subscriber 11,13,15 desires to perform a voice reply to an e-mail message the appropriate voice service is initiated by the subscriber 11,13,15 by the transmission of a suitable request to a suitable voice service provider 34 via the data communication network 32. Service provider 34 responds to the request by the transmission of a specific web page and associated voice service-specific APIs wrapped within the response. The response is sent to the DVS 38 either directly or through WAP gateway 30. DVS 38 accepts the response and subsequently calls the gateway servlet 31 in order to instruct the WAP gateway 30 to suspend the current data session. Until the resumption of the data session DVS 38 controls the integrated data and voice session. The APIs transmitted by the voice service provider 34 within the transmitted web page are specific voice service interface routines developed in VOICE XML, C++, ASP COM objects, JAVA, and the like. The APIs are operative in the execution of the voice service by the voice server 36. DVS 38 processes the response received from the voice service provider 34 and transmits the call to the voice server 36 in order to provide the mobile subscriber 13 with the needed voice service. The subscriber 13 receives the voice-service related web page and interacts with the page in order to perform the recording of the voice message. After the completion of the voice service by the subscriber 13 DVS 38 calls the gateway servlet 31 in order to instruct the WAP gateway 30 to resume the previously interrupted data session. Subsequently, the mobile subscriber 13 is transferred back to the Web navigation mode without being compelled to terminate of the data session.

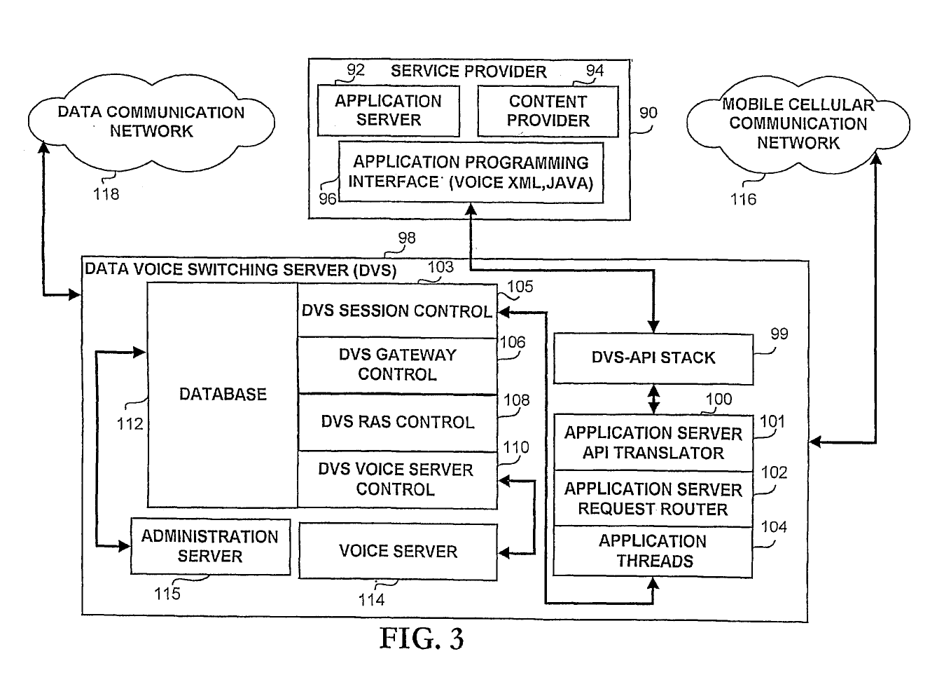

The configuration and functionality of DVS server 38 will be described next. FIG. 3 shows a schematic block diagram of the Data Voice Switching Server, in accordance with a preferred embodiment of the present invention. As illustrated by FIG. 3 DVS server 98 comprises a DVS-API stack 99, an application control segment 100, a DVS control segment 103, an administration server 115, and a voice server 114. Application control segment 100 consists of application server API translator 101, application server request router 102, and application threads 104. DVS control segment 103 consists of DVS session control 105, DVS gateway control 108, DVS RAS control 108, DVS voice server control 110, and database 112. The various components described are shown as co-located within a single platform or environment. It should be noted that the various components could be implemented on any other node on the network access service provider's Intranet. Voice server 114 could be implemented specifically on a specialized voice platform.

DVS 98 operates as an interface between the voice service provider 90 located within the data communication network and the wireless network 116. DVS 98 will usually reside on the network access service provider's Intranet. The functions of the elements shown on FIG. 3 will be described next. The DVS-API stack 99 receives requests from the application server 92 of the voice service provider 90. The requests are transferred to the application server API translator 101. Conversely, the DVS-API stack 99 delivers responses from the application server API translator 101 back to the application server 92 of the service provider 90. The application server API translator 101 transfers the request to the application server request router 102. The router 102 determines the location of the application thread 104 for the specific service provider. The request is sent from the application thread 104 to the DVS session control 105 with a suitable notification sent to database 112. The request is transmitted from DVS session control 105 to DVS gateway control 106 and DVS RAS control 108. The request is sent from the gateway control 106 to the gateway servlet 31 of FIG. 2. Simultaneously the request is sent from the RAS control 108 to the RAS 28 of FIG. 2 in order to sub-address the mobile subscriber's call to an appropriate port number of the voice server 114. The voice server 114 which has received a request notification from the voice server control 110 and received the mobile subscriber's call parameters from the DVS session control 105 executes the required voice activity, such as recording, playing, mobile subscriber's identification, and the like. The administration server 115 supervises and controls the activity of the DVS server 98. It should be noted that a variety of other configurations could be employed for the DVS.

In accordance with the practices of persons skilled in the art of computer programming, the present invention is described below with reference to acts and symbolic representations of operations that are performed by the processing system. It will be appreciated that the acts and symbolically represented operations include the manipulation of electric signals by a central processing unit (CPU). The electrical system represent data bits which cause a resulting transformation or reduction of the electrical signal representation, and the maintenance of data bits at memory locations in the memory system to thereby reconfigure or otherwise alter he CPU's operation, as well as other processing of signals. The memory locations are physical locations that have particular electrical, magnetic, or optical properties corresponding to the data bits. The DVS server and the gateway servlet are sets of computer programs implemented on different computing platforms. The DVS server and the gateway server contain computer software instructions specifically developed for the practice of the present invention. The software in the DVS server and gateway servlet causes the server and the servlet respectively to perform the various functions described herein. Alternatively it is noted dedicated electronic hardware can be made and used to perform all server functionality described herein. In the second case the DVS server and the gateway servlet could be implemented as firmware by the embedding of the predetermined program instructions and/or appropriate control information within suitable electronic hardware devices containing application-specific integrated circuits.

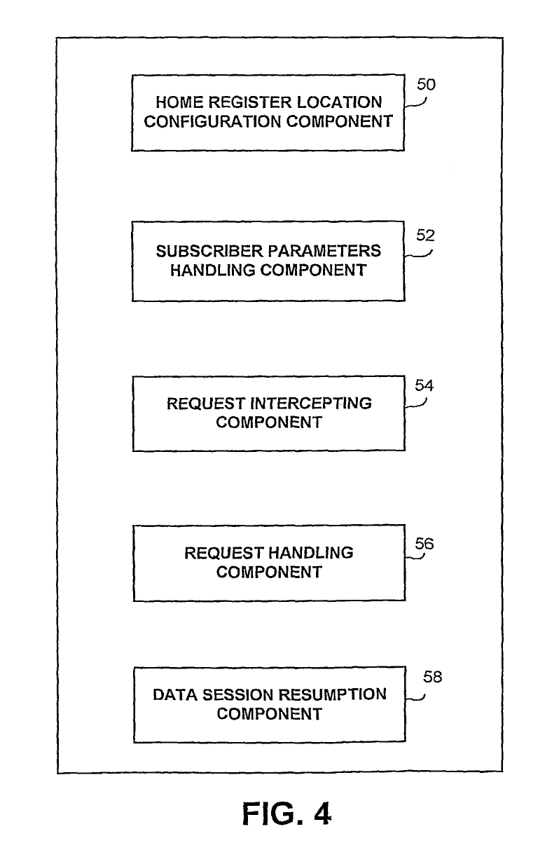

The main program components functional for the integration of voice applications within the framework of a single data session coupled with a WAP-oriented text application are shown in FIG. 4. Referring now to FIG. 4, in order to enable a mobile subscriber to perform voice applications within a data session the Home Register Location (HLR) parameters associated with the specific subscriber should be configured. The Home Location Register (HLR) is a centralized database for storing essential subscriber-specific network control data. The modifications concern the behavior of the system in regard to a specific subscriber. For example in order to compel the mobile subscriber's modem to accept calls while engaged in a data session the subscriber record in the database should be modified. Modifications of certain subscriber-specific parameters will affect the behavior of the mobile network access service provider switch. For example, in case of an incoming call the parameters set to specific values prevent the system from transferring the call to a busy signal or to a voice mail system. Component 50 is designed to configure the appropriate HLR parameter values. Note should be taken that the update can be performed off-line. Subscriber parameters handling component 52 is operative in obtaining the session-specific and the subscriber-specific parameter values from the system and storing the values to be kept for later processing. Request intercepting component 54 activates a loop in which a TCP/IP socket is functionally receptive over a TCP/IP connection for requests from a voice service provider. Component 54 examines intercepted requests, validates intercepted requests, formats such requests and inserts the requests to a predefined dynamic memory area in order to be processed by the request handling components. Request handling component 56 is operative in obtaining the request from the dynamic memory area, instructing the gateway servlet to suspend the data session and activating the voice server to perform voice services for the subscriber. Data Session resumption component 58 extracts the previously saved session and subscriber parameter values and instructs the gateway servlet to resume the previously suspended data session. It should be noted that a variety of other methods could be utilized for accomplishing substantially the same objectives.

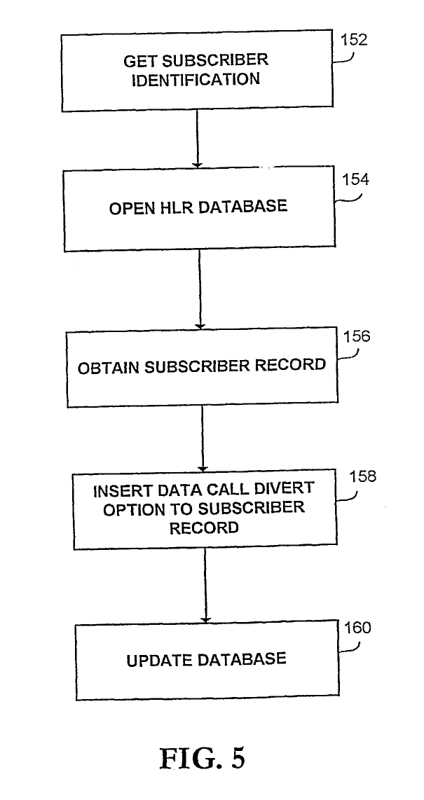

Referring now to FIG. 5 illustrating the operation of the HLR configuration component 50 of FIG. 4. FIG. 5 illustrates the operational steps performed by component 50 of FIG. 4 in order to appropriately configure the Home Location Register (HLR) 27 of FIG. 2. The necessary configuration process is performed in order to provide to subscribers the option of utilizing voice services integrated into a convention data session. Configuring the HLR configuration involves the activation of a specifically developed program product. The program product accepts subscriber-specific input from an external source and applies updates the associated subscribers' records within the HLR. The configuration procedure is typically performed offline and involves manual input by the administrator of the system. At step 152 the identification of a subscriber such as the cellular phone number thereof is obtained. At 154 the HLR database is opened and at step 156 the subscriber's record, indexed by the subscriber's identification, is obtained from the HLR database. A subscriber's HLR record is structured such that specific control fields defining specific subscriber options are given different values. The values are indicative of the provision of specific network operator supplied services to the subscriber. One of the control fields is operative in providing the subscriber with the call waiting service. When the field is set to a specific value the calls made during a period in which the subscriber's device is busy with an another call are diverted to a call-waiting switch to be handled thereby appropriately. Such handling could involve indication to the called party that a call is waiting, or providing the caller with the option of recording a voice message. This call divert field is utilized at step 158. The program will effect the insertion of an additional control value to the field, which will be operative in providing the subscriber with the option of using voice services within a data session. At step 160 the record will be written back to the database.

It would be easily perceived by one with ordinary skill in the art that other diverse methods could be employed in order to indicate the availability of the service for a subscriber. For example, specific control field could be added to the subscriber's record within the HLR database or a new data structure separate from the HLR could be built with a specifically created field within the subscriber's record within the HLR utilized as a pointer to the new structure.

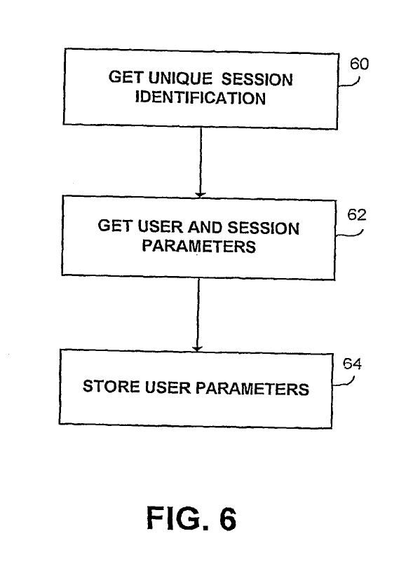

Referring now to FIG. 6 that illustrates the operation of the Subscriber Parameters Handling Component 52 of FIG. 4. Network access service providers typically assign a unique number for each subscriber. In different network schemes the mobile subscriber is identified in different manner. In mobile wireless networks, the subscriber is typically identified by the Mobile Subscriber ISDN (MSISDN) number. MSISDN is used for call related requests and it is visible to both the caller and the subscriber as the dialed number. Thus, requests from the network will be based on MSISDN. The subscriber can be also identified by other identification means, such as the International Mobile Subscriber Identity (IMSI) number, which is typically used in the Global Standard for Mobile communication (GSM) cellular systems. GSM systems are primarily available in Europe. In GSM systems the IMSI is held in the subscriber identity module (SIM) of the mobile station, typically on a “SIM card” that is inserted inside all GSM wireless devices in order to identify the subscriber to the GSM network. The ISMI is not visible or accessible to the subscriber.

Each data session is assigned a unique ID by the network access service provider. The DVS server 38 retrieves the unique session ID by utilizing the subscriber's identification number such as a MSISDN number as a key (step 60). At step 62 the DVS 38 by using the standard Remote Authentication Dial-In User Service (RADIUS) protocol interfaces to a RADIUS server in order to obtain the subscriber's parameter values. RADIUS is an authentication and accounting system used by many service providers. When a subscriber dials in to a service provider the user typically enters the username and the password thereof. The information is passed to a RADIUS server, which checks that the information is correct, and then authorizes access to the system. The information is also stored on the RADIUS server for the duration of a session. The DVS retrieves the stored values from the RADIUS server by indexing the current session identification value into the RADIUS database. The parameters thus obtained include the subscriber's IP address, the subscriber's user-name, and the password thereof. The information is stored in the database of the DVS server 38 (at step 64) to be used after the completion of the voice service for the resumption of the suspended data session.

In other embodiments of the present invention other methods could be employed. For example, the DVS could retrieve and store the subscriber information form the network access service provider independently of the RADIUS server or the DVS could assign a specific session identification to be connected to the unique session identification allocated by the network access service provider.

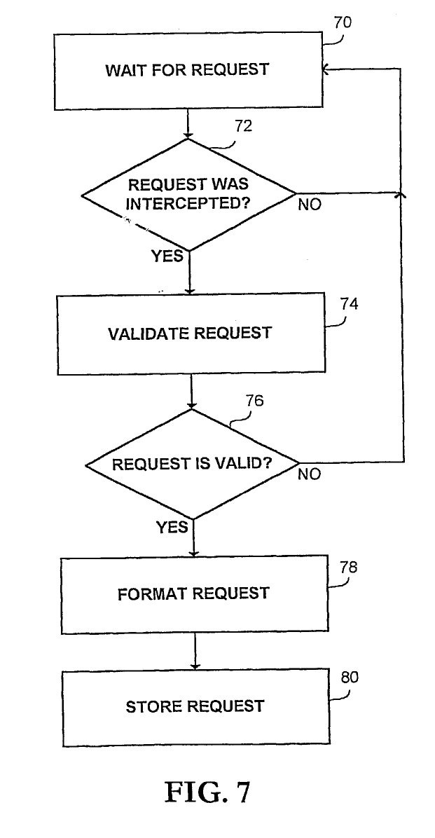

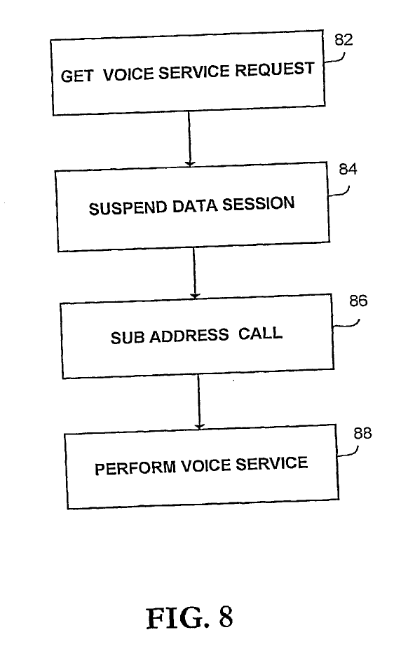

FIG. 7 is the method for intercepting voice service-related requests transmitted by a service provider. The method is utilizing a TCP/IP socket or an endpoint in a connection to be functionally receptive to a request from the service provider over a TCP/IP connection (step 70). The socket is created and used by utilizing a known set of programming requests or socket APIs. In other embodiments of the present invention other connection methods could be used For example, the UNIX C sockets could be utilized. At step 72 the method performs a check regarding the interception of a request from the voice service provider. If no request was intercepted then the method's control effects a return to step 70 in order to wait for further incoming requests. If a request interception event is recognized then at step 74 the intercepted request is validated. The validation process checks the subscriber's identification and the introduced password in order to determine whether the request's origin is known to the system. If the request is valid at step 78 the request is formatted to a structure suitable for insertion to a memory device. Additional information such as the service type and control data is attached to the formatted record. At step 66 the request is inserted into a dynamic memory device, such as a buffer, ready for processing by the request handler component. FIG. 8 shows the operation of the request handling component 56 of FIG. 4. At step 82 the request handler component retrieves an intercepted, validated, and formatted request from the dynamic memory device, such as a buffer. Next, at step 84 the request handler transmits a command to the gateway servlet associated with the WAP gateway to suspend the currently managed data session. As a result the WAP gateway server suspends the session and notifies the handler of the event by transmitting a confirmation message to the DVS 38. The suspension of the data session does not terminate the session allowing a voice session to be initiated and conducted at the same time as the session data is pending. At step 86 the handler instructs the network access service provider switch 26 to sub-address the call to the voice server 36. The switch sub-addresses the call to the voice server 36 and sends confirmation to the handler. Subsequently voice server 36 opens a voice channel and a virtual data channel to the subscriber 10,12,14. Opening of the voice channel while the data channel is suspended enables the gateway server 30 to later resume the data channel automatically and without need for the subscriber to initiate a new request for a data channel. At step 88 the requested voice service is performed by the voice server subsequent to the appropriate command sent by the handler to the voice server 36.

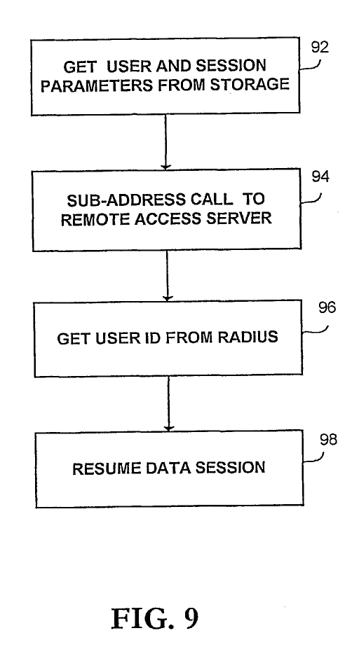

FIG. 9 illustrates the operation of the data session resumption component 58 of FIG. 4. Subsequent to the completion of the voice service the previously suspended data session is restarted by the Data Session Resumption component 58 of FIG. 4. At step 92 the previously saved session and subscriber parameter values are read from the storage. The component sub-addresses the call to the RAS at step 94. At step 96 the stored subscriber identification is retrieved from the RADIUS server and at step 98 a command is sent to the gateway servlet associated with the gateway server to resume the data session. The gateway server resumes the session and provides the subscriber with the option of continuing the previously suspended Web navigation.

It will be easily perceived by one with ordinary skill in the art that the steps and components mentioned in the foregoing description were provided as examples and were not intended to be limiting. Diverse other components and methods could be used to accomplish the underlying objectives of the present invention and several enhancements and improvements to the described embodiment could be contemplated within the framework of the general issues inherent in the proposed system.

The above description of the construction and use of systems incorporating a plurality of mobile terminals, base stations, switches, transceivers, modems, and servers makes particular reference to use in a land based communication system. However, it will be understood that the use of the technique is in no way limited to land based systems and that it is equally applicable to mobile communication systems incorporating geo-stationary, middle-earth-orbit, or low-earth-orbit satellite nodes.

Persons skilled in the art will appreciate that the present invention is not limited to what has been particularly shown and described hereinabove. Rather the scope of the present invention is defined only by the claims, which follow.

I/we claim:

1. In a first communication network having at least one subscriber device connectable the first communication network via a network access service provider switch, the at least one subscriber device connectable to at least one service provider device operating within a second communication network via a gateway device, a method for providing to the at least one subscriber device with a communication session with integrated data and voice services, the method comprising the steps of:
identifying the subscriber device associated with a data communication session in the first communication network; and intercepting voice service related request transmitted from the service provider device in the second communication network to the subscriber device associated with the data communication session in the first communication network; and
logically linking the intercepted voice service related requests from the service provider device in the second communication network with the subscriber device associated with the data communication session in the first communication network; and
suspending the data communication session associated with the subscriber device between the subscriber device in the first communication network and the second communication network.

2. The method of claim 1, further comprising the steps of:
opening a virtual communication session associated with the subscriber device in the first communication network; and
performing the requested voice service within the framework of the virtual communication session associated with the subscriber device in the first communication network.

3. The method of claim 1 further comprising the step of resuming the data communication session between the subscriber device associated with the data communication session in the first communication network and the second communication network.

4. The method of claim 1 wherein the step of identifying comprises the steps of:
determining a voice service-related operational parameter of the subscriber device in the first communication network; and
obtaining a unique identification of the subscriber device in the first communication network; and
locating in a central subscriber control data structure a unique control record associated with the subscriber device in the first communication network; and
modifying the contents of the unique control record associated with the subscribe device in the first communication network in accordance with the determined voice-service related parameter; and
updating the central subscriber control database with the modified unique control record associated with the subscriber device in the first communication network.

5. The method of claim 1 wherein the step of intercepting comprises the steps of:
functionally receiving in the first communication network voice service requests transmitted by the service provider in the second communication network; and
validating the received voice service requests in the first communication network; and
formatting the received and validated voice service requests in the first communication network.

6. The method of claim 1 wherein the step of logically linking comprises the steps of:
obtaining a unique identification of the data communication session associated the subscriber device in the first communication network; and
obtaining operational parameters of the data communication session associated with the subscriber device in the first communication network; and
obtaining operational parameters of the subscriber device associated with the data communication session in the first communication network; and
attaching the unique identification of the data communication session to the operational parameters of the data communication session and to the operational parameters of the subscriber device associated with the data communication session; and
storing the attached subscribe device parameters with the associated data communication session parameters.

7. The method of claim 1 wherein the step of suspending comprises the step of instructing the gateway device operative in the managing of the data communication session to interrupt the data communication session.

8. The method of claim 2 wherein the step of performing comprises the steps of:
opening a virtual voice connection between the subscriber device and a voice processor device in the first communication device; and
opening a virtual data connection between the subscriber device and a data and voice switching device in the first communication network; and
operatively controlling the virtual voice data session in the first communication network.

9. The method of claim 3 wherein the step of resuming comprises the steps of:
obtaining the unique data session identification and associated subscriber device parameters in the first communication network; and
instructing the gateway device to re-open the data communication session in accordance with the unique data communication session and subscriber device data in the first communication network.

10. The method of claim 1 wherein the communication session in the first communication network includes multimedia services.

11. The method of claim 5 wherein the voice request is validated by checking the source of the voice request in the first communication network.

12. The method of claim 9 wherein the source of a voice request is a subscriber device in the first communication network.

13. In communication network a method for automatically suspending and resuming data sessions of mobile device subscribers for enabling the subscribers to receive non-data sessions while engaging in data sessions comprising the step of instructing a gateway device operative in the managing of the data communication session to interrupt the data communication session, suspend the data communication session and enable other non-data session.

14. In a first communication network having at least one subscriber device connectable the first communication network via a network access service provider switch, the at least one subscriber device connectable to at least one service provider device operating within a second communication network via a gateway device, the at least one subscriber identified and logically linked with a voice service, a method for providing to the at least one subscriber device with a communication session with integrated data and voice services, the method comprising the steps of:
suspending the data communication session associated with the subscriber device between the subscriber device in the communication network and the second communication network.
opening a virtual communication session associated with the subscriber device in the first communication network; and
performing the requested voice service within the framework of the virtual communication session associated with the subscriber device in the first communication network; and
resuming the data communication session between the subscriber device associated with the data communication session in the first communication network and the second communication network.

15. In a first communication network having a first subscriber device connectable to a first network access service provider switch, at least one subscriber device in the first communication network connectable to at least one service provider device operating within a second communication network via a gateway device, a system for the management of a communication session with integrated data and voice services, the system comprises the elements of:
a data and voice switching server to control the integration of data and voice services into a data and voice session associated with the subscriber device in the first communication network; and
a gateway device controller to suspend and resume the data communication session.

16. The system of claim 15 wherein the element of the data and voice switching server comprises the elements of:
an service provider application server interface translator to effect translation of the interface received from the service provider in the second communication network; and
an service provider application server request router to connect requests received from the service provider in the second communication network to a data communication session in the first communication network; and
a data voice session controller to control the data voice session in the first communication network; and
a remote access server controller to control the remote access server in the first communication network; and
a voice server controller to control the voice server in the first communication network.

17. The system of claim 15 further comprising a voice server to provide voice services to the subscriber device associated with the data and voice session in the first communication network.

18. The systems of claim 15 further comprising a network access service provider switch to route voice service related requests to the data voice switching server in the first communication network.

19. The system of claim 15 further comprising a database to hold subscriber device control information in the first communication network.

20. The system of claim 15 further comprising a remote access server to connect the subscriber device to the gateway device in the first communication network.

21. The system of claim 15 further comprising of a gateway server to provide a link between the first communication network and the second communication network within the framework of a data communication session.

22. The system of claim 15 wherein the first communication network is a WAP-compliant cellular telephone network.

23. The system of claim 15 wherein the second communication network is the data network.

24. The system of claim 15 wherein the subscriber device in the first communication network is a cellular telephone device.

25. The system of claim 15 wherein the subscriber device in the first communication network is a digital assistance device.

26. The system of claim 19 wherein the database is a location register component.

27. The system of claim 23 wherein the data network is the Internet.

28. In a wireless communication network having a plurality of wireless devices associated with subscribers the wireless devices connectable to other wireless devices in the wireless communication network via a wireless network access service provider switch, a method for providing the wireless devices associated with subscribers a data communication session having integrated data and voice services, the method comprising the steps of:
classifying the subscriber device associated with a data communication session in the wireless communication network; and
capturing voice service requests forwarded from the service provider device through the gateway device in the data communication network to the wireless device associated with the data communication session in the wireless communication network; and
coupling the captured voice service requests from the service provider device in the data communication network to the wireless device associated with the data communication session in the wireless communication network; and
suspending the data communication session associated with the wireless device between the wireless device in the wireless communication network and the data communication network; and
opening a data and voice communication session associated with the wireless device in the wireless communication network; and
executing the requested voice service within the framework of the data and voice communication session associated with the wireless device in the wireless communication network; and
resuming the suspended data communication session between the wireless device associated with the data communication session in the wireless communication network and the data communication network.

29. The method of claim 28 wherein the step of identifying comprises the steps of:
determining a voice service-related parameter of the wireless device in the wireless communication network; and
obtaining a unique identification of the wireless device in the wireless communication network; and
locating in a central wireless device control data structure a unique control record associated with the wireless device in the wireless communication network; and
modifying the contents of the unique control record associated with the wireless device in the wireless communication network in accordance with the determined voice service-related parameter; and
updating the central wireless device control database with the modified unique control record associated with the wireless device in the wireless communication network.

30. The method of claim 28 wherein the step of capturing comprises the steps of:
receiving in the wireless communication network voice service requests forwarded by the service provider in the data communication network; and
validating the received voice service requests in the wireless communication network.

31. The method of claim 28 wherein the step of coupling comprises the steps of:
identifying the data communication session associated the wireless device in the wireless communication network; and
reading operational parameters of the data communication session associated with the wireless device in the wireless communication network; and
obtaining operational parameters of the wireless device associated with the data communication session in the wireless communication network; and
combining the unique identification of the data communication session with the operational parameters of the data communication session and with the operational parameters of the wireless device associated with the data communication session; and
storing the combined wireless device parameters with the associated data communication session parameters.

32. The method of claim 28 wherein the step of suspending comprises the step of instructing the gateway device to terminate the data communication session.

33. The method of claim 28 wherein the step of performing comprises the steps of:
opening a virtual voice session associated with the wireless device by a voice processor device in the wireless communication device; and
opening a voice connection between the wireless device and a data and voice switching device in the wireless communication network; and
operatively controlling the voice and data session in the wireless communication network.

34. The method of claim 28 wherein the step of resuming comprises the steps of:
obtaining the unique data communication session identification and associated wireless device parameters in the first communication network; and
instructing the gateway device to re-open the data communication session in accordance with the unique data communication session and the wireless device data in the wireless communication network.

35. The method of claim 28 wherein the data communication network is the Internet.

36. The method of claim 28 wherein the wireless communication network is a WAP-compliant cellular telephone network.

37. The method of claim 28 wherein the wireless device in the wireless communication network is a WAP-compliant cellular telephone device.

38. The method of claim 28 wherein the wireless device in the wireless communication network is a WAP-compliant personal assistance device.

39. The method of claim 28 wherein the voice services integrated into the data and voice communication session are the recording of voice messages, voice replies to e-mail, text-to-voice, and voice recognition.

40. The method of claim 28 wherein the unique wireless device identification is provided by the Mobile Subscriber ISDN.

41. The method of claim 28 wherein the unique wireless device parameters are obtained from the RADIUS server.

42. In a communication network a method for providing data and voice integrated services comprising:
capturing voice service requests forwarded from a service provider device through a gateway device in a data communication network to a wireless device associated with a data communication session in a wireless communication network; and
coupling the captured voice service requests to a wireless device associated with the data communication session in the wireless communication network; and
suspending the data communication session associated with the wireless device between the wireless device in the wireless communication network and the data communication network; and
opening a communication session associated with the wireless device in the wireless communication network.

43. The method of claim 42 wherein the communication session is a voice session.

44. The method of claim 42 wherein the communication session is a data session.

45. The method of claim 42 wherein the communication session is a rich media session.
